(19) United States
(12) Patent Application Publication
(10) Pub. No.: US 2005/0138580 A1
(43) Pub. Date: Jun. 23, 2005

(54) Method of generating dependency specification file capable of reconfiguring function block of soft IP and recording medium storing codes embodying the method

(76) Inventors: Tae Young Lim, Daejeon-city (KR); Myung Shin Kwak, Daejeon-city (KR); Jong Dae Kim, Daejeon-city (KR); Hi Seok Kim, Seoul (KR); Yang Ki Cho, Chungcheongbuk-do (KR); Seung Wan Song, Kyungki-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/937,237

(22) Filed: Sep. 8, 2004

(30) Foreign Application Priority Data
Dec. 17, 2003 (KR) 2003-92589

(51) Int. Cl. G06F 17/50

(52) U.S. Cl. 716/3

(57) ABSTRACT

Provided is a method of generating a dependency specification file of a soft IP comprising, extracting constituent element information by parsing a netlist file of a soft IP and designating an instance name and a component name to input and output ports and function blocks which are constituent elements existing in the soft IP, converting the constituent element information to a vertex for each constituent element, indicating a dependency specification between the vertexes for the respective constituent elements, and generating a dependency specification file by converting the vertexes for the respective constituent elements and the dependency specification that the netlist file of the soft IP contains to an electronic circuit design language file, and outputting the dependency specification file.

### BACKGROUND OF THE INVENTION

This application claims the priority of Korean Patent Application No. 2003-92589, filed on Dec. 17, 2003, in the Korean Intellectual Property Office, the disclosure of which is incorporated herein in its entirety by reference.

1. Field of the Invention

The present invention relates to an electronic circuit design, and more particularly, to a method of generating a dependency specification file capable of reconfiguring function blocks of a soft intellectual property (IP) represented in an electronic circuit design language, and a recording medium storing codes embodying the method.

2. Description of the Related Art

A design tool that can configure a circuit and simulate it using an electronic circuit design language such as VHDL (very high speed description language) or VERILOG is used for designing an electronic circuit such as a system on a chip (SoC). An IP (electronic circuit design intellectual property) designer should provide a design tool so that a user in designing an electronic circuit can easily reconfigure function blocks relating to the electronic circuit and simulate the electronic circuit and finally embody the electronic circuit into a chip. In designing an electronic circuit, an IP user designs an electronic circuit using a user-friendly high level language such as VHDL or VERILOG. Thereafter, the IP user can simulate the electronic circuit designed using the high level language using the same design tool, to check whether the electronic circuit operate normally. The IP user completes a soft IP (electronic circuit design intellectual property represented using an electronic circuit design language) that is semiconductor design intellectual property through a series of design processes using the design tool. Since the soft IPs exist in a variety of forms, the soft IP user can easily design an electronic circuit using a soft IP capable of reconfiguring.

FIG. 1 is a block diagram showing a conventional method of reconfiguring function blocks in a soft IP. Referring to FIG. 1, in the conventional method of designing a soft IP 110 to have a capability of reconfiguration, an IP designer develops and provides a soft IP 120 including various function blocks 121 and 123-125 which can be selected and a selection circuit 122. The IP designer develops and provides additional exclusive selection program file 130 applied only to the corresponding IP 120 as well, so that the user can select and connect necessary function blocks. However, according to the conventional method, since the selection circuit 130 and the additional exclusive selection program file 130 are needed, a great deal of time and efforts is required in designing the IP and the size of the IP increases accordingly. Furthermore, since the IP user may use a soft IP having unnecessary function blocks and selection circuit, the size of a chip may increase when the soft IP is embodied in a chip.

FIG. 2 is a block diagram showing another conventional method of reconfiguring function blocks in a soft IP. Referring to FIG. 2, in this conventional method of designing a soft IP 210 to have a capability of reconfiguration, an IP designer develops and provides soft IPs 220 and 230 including various function blocks 221 and 222, or 231, 232, and 233 which can be selected. Upon request by a user, the IP designer performs redesign and reconfiguration so that function blocks desired by the user only are connected. However, in this method, since a great deal of time and efforts is required in designing the IP, it is a problem that the user cannot independently select function blocks only that the user desires.

### SUMMARY OF THE INVENTION

To solve the above and/or other problems, the present invention provides a method of generating a dependency specification file of a soft IP for designing a new or existing electronic circuit having a function to define and describe interdependency of constituent elements existing in the soft IP to make the soft IP have a capability of reconfiguring so that a user can easily edit the soft IP, and a recording medium storing codes embodying the method.

According to an aspect of the present invention, a method of generating a dependency specification file of a soft IP comprises extracting constituent element information by parsing a netlist file of a soft IP and designating an instance name and a component name to input and output ports and function blocks which are constituent elements existing in the soft IP, converting the constituent element information to a vertex for each constituent element, indicating a dependency specification between the vertexes for the respective constituent elements, and generating a dependency specification file by converting the vertexes for the respective constituent elements and the dependency specification that the netlist file of the soft IP contains to an electronic circuit design language file, and outputting the dependency specification file.

In indicating a dependency specification, a degree of dependency between the vertexes for the respective constituent elements is defined.

The vertexes for the respective constituent elements are classified as a dependent vertex that is dependent on other vertex, a dominant vertex that is dominant over other vertex, and an absolute vertex that is self-recursive.

Indicating a dependency specification comprises calculating the number of vertexes dependent on each vertex for each vertex, determining whether the vertex is stable or unstable for each vertex according to the number of the dependent vertexes, and removing vertexes corresponding to a predetermined removal rule.

In determining whether the vertex is stable or unstable, when the number of the vertexes that are dependent is one or more, the vertexes are determined to be stable and, when the number of the vertexes that are dependent is 0, the vertexes are determined to be unstable.

Removing vertexes comprises removing vertexes that are determined to be unstable, and if a vertex where at least one vertex dependent on the vertex exists is to be removed, removing all vertexes that are in relation of the dependent vertex among the vertexes dependent on the vertex to be removed.

The electronic circuit design language file includes VHDL (very high speed description language), VERILOG, XNF (xilinx netlists format), and EDIF (electronic data interchange format).

According to another aspect of the present invention, in a recording medium storing computer readable and executable codes for generating a dependency specification file of a soft IP, the codes performs functions of extracting constituent element information by parsing a netlist file of a soft IP and designating an instance name and a component name to input and output ports and function blocks which are constituent elements existing in the soft IP, converts the constituent element information to a vertex for each constituent element, indicates a dependency specification between the vertexes for the respective constituent elements, and generates a dependency specification file by converting the vertexes for the respective constituent elements and the dependency specification that the netlist file of the soft IP contains to an electronic circuit design language file, and outputting the dependency specification file.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram showing a conventional method of reconfiguring function blocks in a soft IP;

FIG. 2 is a block diagram showing another conventional method of reconfiguring function blocks in a soft IP;

FIG. 3 is a block diagram showing a method of generating a dependency specification file of a soft IP according to an embodiment of the present invention;

FIG. 4 is a flow chart for explaining the method of generating a dependency specification file of FIG. 3;

FIG. 5 is an exemplary view of a hierarchic circuit of the soft IP according to an embodiment of the present invention;

FIG. 6 is an exemplary view of a VHDL text with respect to FIG. 5;

FIG. 7 is an exemplary view of a VERILOG text with respect to FIG. 5;

FIG. 8 is an exemplary view of constituent element information with respect to FIG. 5;

FIG. 9 is an exemplary view declaring vertexes of the constituent element information extracted from FIG. 5;

FIGS. 10A and 10B are views for explaining a dependency vertex and a ruling vertex according to an embodiment of the present invention;

FIGS. 11A and 11B are views for explaining relationship between two vertexes that are ruling vertexes according to an embodiment of the present invention;

FIGS. 12A and 12B are views for explaining an absolute vertex according to an embodiment of the present invention;

FIG. 13 shows an example of a dependency specification file format according to an embodiment of the present invention;

FIG. 14 shows an example of a library definition portion of FIG. 13;

FIG. 15 shows an example of a vertex declaration portion of FIG. 13; and

FIG. 16 shows an example of a dependency definition portion of FIG. 13.

### DETAILED DESCRIPTION OF THE INVENTION

In the following descriptions, the same reference numerals denote the same elements throughout the accompanying drawings.

To summarize terms used in the descriptions, “IP” (intellectual property) denotes an electronic circuit design intellectual property and hereinafter the “IP” and the “electronic circuit design intellectual property” have the same meaning. “Soft IP” denotes the electronic circuit design intellectual property represented by an electronic circuit design language such as a VHDL (very high speed description language) and VERILOG, to embody an electronic circuit. “Reconfigurable design” denotes that a soft IP designer designs a soft IP so that it can be reconfigured by selecting constituent elements according to a predetermined purpose. When a soft IP designed as above is applied to a system on chip (SoC) design, a semiconductor chip having a minimized area can be embodied. “Constituent element” denotes input/output ports and function blocks represented by the electronic circuit design language in the soft IP. “DSF (dependency specification filing or dependency specification file)” denotes making a file describing dependency as a specification or a file thereof. “Recording medium” denotes a program describing a dependency specification file (DSF) and has a form of a file. “IP designer” denotes a person who creates a integrated circuit design intellectual property. “IP user” denotes a person who applies and inserts IPs to and in a system when the system is designed.

In the electronic circuit design such as a system on chip (SoC), a design tool is used which can configure a circuit using an electronic circuit design language such as VHDL or VERILOG and simulate the circuit. The IP (electronic circuit design intellectual property) designer should provide a design tool so that, in designing an electronic circuit, a user can easily reconfigure function blocks relating to the electronic circuit and simulate the electronic circuit and finally embody the electronic circuit as a chip. A method of generating a DSF of a soft IP according to an embodiment of the present invention which is described below concerns a method by which a user easily reconfigures function blocks relating to an electronic circuit from a soft IP using a design tool and simulate the electronic circuit and finally embodies the electronic circuit as a chip. That is, the following operation and process are realized using a predetermined database needing a processor in a computer and can be realized by other hardware when necessary.

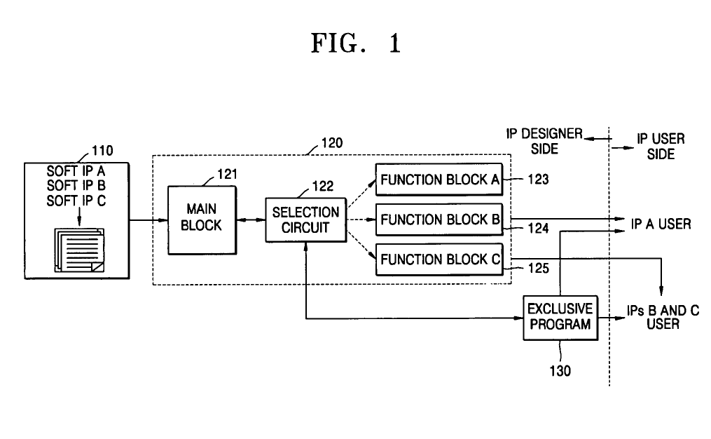

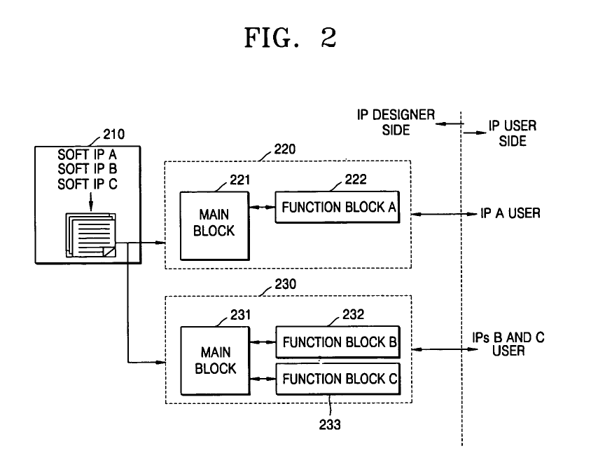

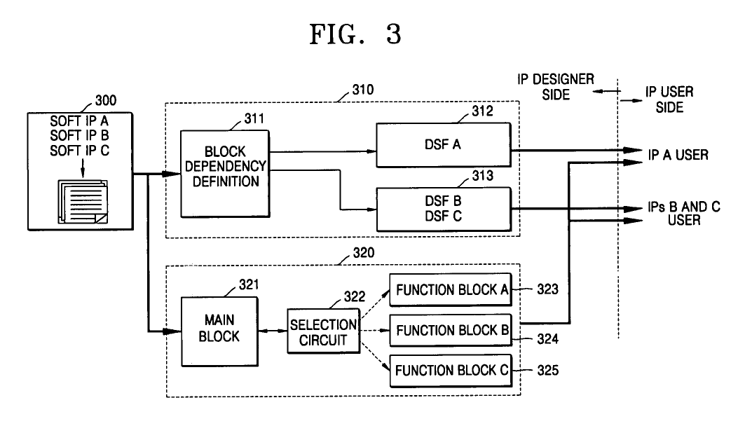

FIG. 3 is a block diagram showing a method of generating a dependency specification file of a soft IP according to an embodiment of the present invention. A soft IP 300 of FIG. 3 may have a reconfiguration capability. Accordingly, an IP user can obtain an optimal soft IP by reconfiguring desired constituent elements through the soft IP 300 provided by an IP designer, using DSFs 312 and 313 generated from the soft IP 300. As a result, the IP user can design and embody a chip having a minimized area. Referring to FIG. 3, in the method of generating a DSF of the soft IP 300 according to an embodiment of the present invention, the IP designer develops and provides an existing or new soft IP 320 having various function blocks 321 and 323-325 which can be selected and a selection circuit 322. Also, the IP designer develops and provides various DSFs 312 and 313 describing a dependency specification between the respective function blocks 321 and 323-325 through a block dependency definition unit 311, that is, the DSFs 312 and 313 which can generate files for selecting constituent elements. By using the existing or new soft IP 320 having the selection circuit 322, without the exclusive program 130 shown in FIG. 1, a function block A 323 is selected by a first DSF 312 and function blocks B and C 324 and 325 are selected by a second DSF 313.

The method of generating a DSF of the soft IP 300 according to an embodiment of the present invention is described in detail.

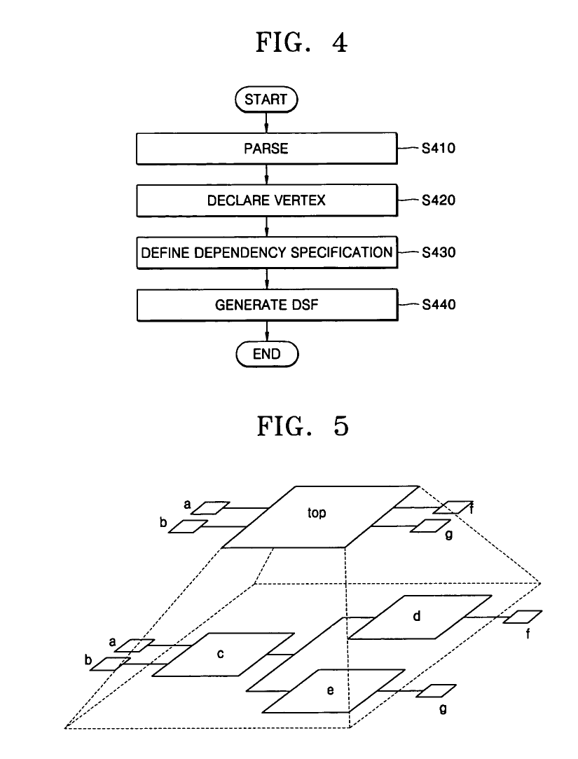

FIG. 4 is a flow chart for explaining the method of generating a dependency specification file of FIG. 3. Referring to FIG. 4, steps of generating the DSFs 312 and 313 from the soft IP 300 according to the embodiment of the present invention are explained. The new or existing soft IP 300 described using an electronic circuit design language such as VHDL (very high speed description language), VERILOG, XNF (xilinx netlists format), and EDIF (electronic data interchange format), has a netlist file.

In first step S410 of FIG. 4, using a parser that is a program translating and processing information input to a computer, the grammar structure of a netlist file with respect to the soft IP 300 is analyzed, an instance name and a component name are designated to function blocks and ports which are constituent elements, and constituent element information is extracted. In first step S410 of FIG. 4, constituent element information is extracted as shown in FIG. 8. FIGS. 5 through 7 are described to explain FIG. 8.

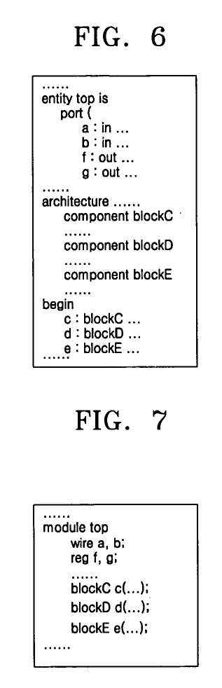

FIG. 5 is an exemplary view showing a hierarchic circuit of the soft IP according to an embodiment of the present invention. FIG. 6 is an exemplary view of a VHDL text corresponding to FIG. 5. FIG. 7 is an exemplary view of a VERILOG text corresponding to FIG. 5. FIG. 8 is an exemplary view of constituent element information corresponding to FIG. 5.

Referring to FIG. 5, a hierarchic structure of an uppermost block and lower blocks in the soft IP is shown. That is, it is assumed that the uppermost block “top” includes sub-function blocks c, d, and e and that the uppermost block “top” is a circuit operating through ports a, b, f, and g. The exemplary circuit of FIG. 5 can be represented in a VHDL text as shown in FIG. 6 and in a VERILOG text as shown in FIG. 7. The electronic circuit design intellectual property represented by these electronic circuit design languages becomes a soft IP. In a description in reference to both FIGS. 6 and 8, the ports a, b, f, and g and the function blocks c, d, and e of FIG. 6 are described as the instance name A of FIG. 8. Thus, in FIG. 8, the instance name A refers to the function block or ports, which is exampled among the constituent elements in a designed circuit. In FIG. 8, the component name B is indicated as “INPUT” or “OUTPUT” with respect to the respective input and output ports. The input and output ports can be indicated as “INOUT”. As shown in a doted box C of FIG. 8, the component name B with respect to each of the function blocks c, d, and e are indicated as “blockC”, “blockD”, and “block E”. The constituent element information classifies the constituent elements in the soft IP.

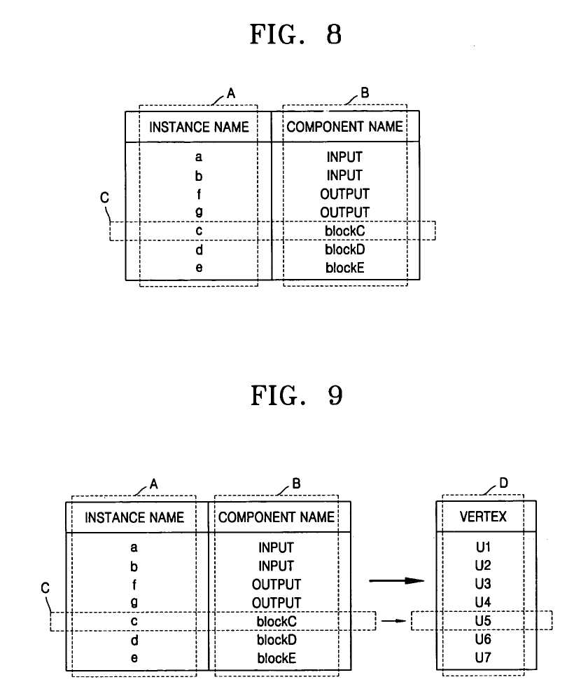

Next, in second step S420 of FIG. 4, the extracted constituent element information is converted to a vertex for each constituent element. The vertex is an element of a graph mapping to each instance in FIG. 8 and is indicated as a doted box D in FIG. 9. Here, the name of the vertex can be designated at the user's discretion. The vertex classifies the constituent elements in the soft IP 300 classified in step S410, in which constituent element information is extracted, into forms which can be described using the electronic circuit design language. The instance c of FIG. 8 can be declared as a vertex “U5” in FIG. 9.

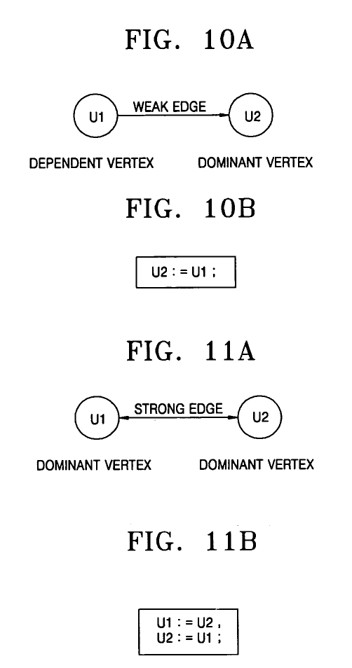

In third step S430 of FIG. 4, a dependency specification between vertex for each constituent element is indicated. The dependency specification defines a degree of dependency between vertexes of the constituent elements. FIGS. 10A, 10B, 11A, 11B, 12A, and 12B are views for explaining defined terms in the dependency specification. FIGS. 10A and 10B are views for explaining a dependent vertex and a dominant vertex according to an embodiment of the present invention. Referring to FIG. 10A, when an arrow directs from a vertex U1 to a vertex U2, the vertex U1 is a dependent vertex while the vertex U2 where the arrow arrives is a dominant vertex. The arrow indicated to direct only in one direction in FIG. 10A is referred to as a weak edge. Regarding the dependency between the vertexes U1 and U2 of FIG. 10A, since a weak edge directing from U1 to U2 exists, it is expressed that U1 is dependent on U2 while U2 is dominant over U1. Here, the dependency specification is defined as “U2:=U1;” as shown in FIG. 10B.

FIGS. 11A and 11B are views for explaining the relationship between two vertexes that are dominant vertexes according to an embodiment of the present invention. Referring to FIG. 11A, when an arrow directs in both directions between the vertex U1 and the vertex U2, the bidirectional arrow is referred to as a strong edge. Thus, regarding the dependency between the vertexes U1 and U2 shown in FIG. 11A, since a strong edge directing from U1 to U2 and from U2 to U1 exits, it is expressed that U1 is dominant over U2 and simultaneously U2 is dominant over U1. Here, the dependency specification is defined as “U1:=U2; and U2:=U1;” as shown in FIG. 11B.

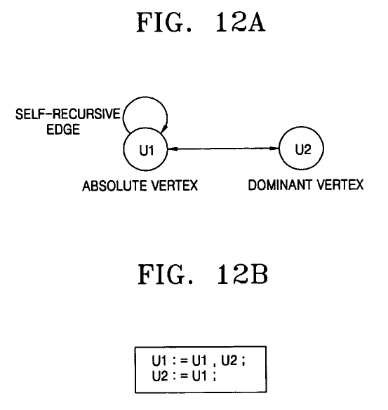

FIGS. 12A and 12B are views for explaining an absolute vertex according to an embodiment of the present invention. Referring to FIG. 12A, an edge dependent on one's vertex U1 is referred to as a self-recursive edge. Also, regarding the dependency of the vertexes U1 and U2 in FIG. 12A, since U1 have a self-recursive edge, it is expressed that U1 is an absolute vertex while U2 is dominant over U1. Here, the dependency specification is defined as “U1:=U1,U2; and U2:=U1;” as shown in FIG. 12B. In the rule to define the dependency specification, when a degree of dependency between the vertexes can be expressed, any term or rule can be used although the above terms and rules are used in the present embodiment.

Referring to FIGS. 10 through 12, optimization summary rules with respect to the dependency specifications, that is, [Optimization summary rule 1] through [Optimization summary rule 5] are defined.

[Optimization Summary Rule 1]

For a certain vertex U1, the number of vertexes dependent on the vertex U1 is used to determine stability of the vertex U1.

[Optimization Summary Rule 2]

For a certain vertex U1, when the stability of the vertex U1 is 0, the vertex U1 is unstable.

[Optimization Summary Rule 3]

For a certain vertex U1, when the stability of the vertex U1 is not less than 1, the vertex U1 is stable.

[Optimization Summary Rule 4]

The unstable vertexes are removed.

[Optimization Summary Rule 5]

For a certain vertex U1, when one or more vertexes dependent on the vertex U1 are present and the vertex U1 is to be removed, the vertexes connected by a weak edge, that is, the dependent vertexes, among the vertexes that are defendant on the vertex U1, are all removed.

In third step S430 of FIG. 4, in which the dependency specification is indicated, when the vertexes for each constituent element are classified as the dependent vertex, the dominant vertex, and the self-recursive vertex, vertexes such as unstable vertexes that a user desires are removed. The optimization summary rules can be applied when dependency specification files according to an embodiment of the present invention are used. As the user applies these rules, a soft IP can be optimized. That is, in third step S430, the number of vertexes dependent on each vertex is calculated for each vertex using the optimization summary rule 1 and whether each vertex is stable or unstable is determined according to the number of the dependent vertexes using the optimization summary rule 3. When each vertex is determined to be stable or unstable, the vertexes determined to be unstable is removed using the optimization summary rule 4. Also, when a vertex on which one or more vertexes dependent on the vertex are present is to be removed using the optimization summary rule 5, all the dependent vertexes among the vertexes dependent on the vertex to be removed are removed.

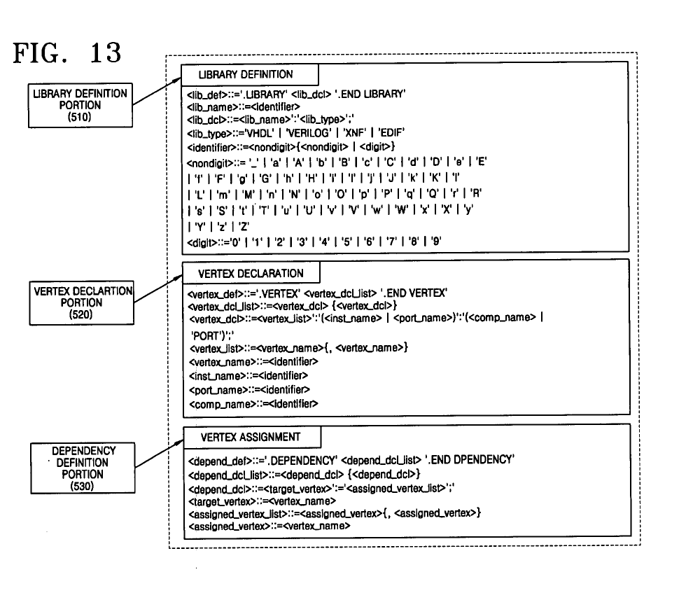

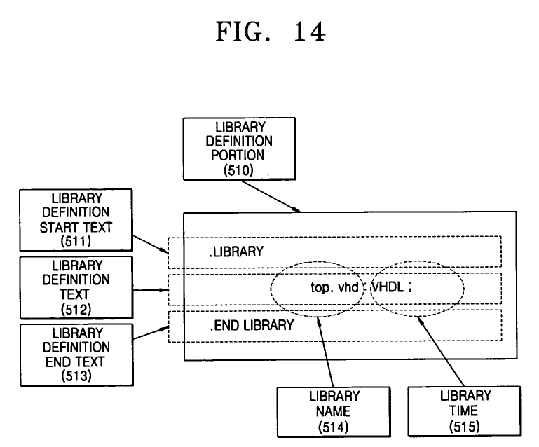

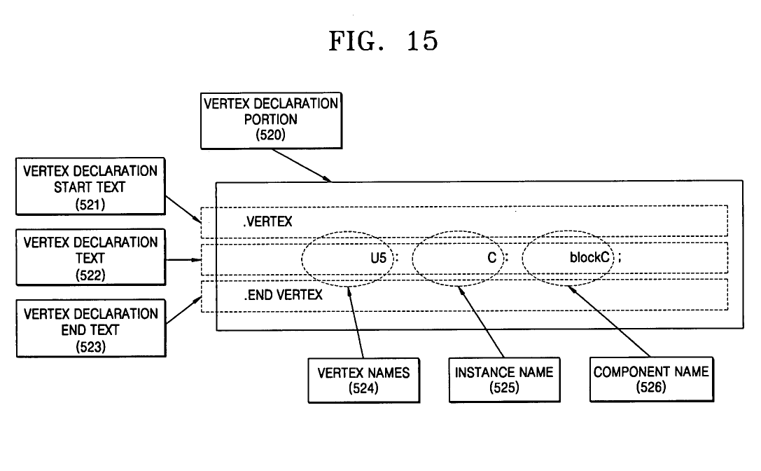

In fourth step S440 of FIG. 4, a DSF is generated by converting the vertexes for each constituent element and the dependency specification in the netlist file of the soft IP, and output. FIG. 13 shows an example of a dependency specification file format according to an embodiment of the present invention. In a dependency specification file format according to an embodiment of the present invention, that is, a DSF, dependency between the respective vertexes defined by the dependency specifications is set forth in a format as shown in FIG. 13.

Referring to FIG. 13, the DSF represented in a Backus-Naur format (BNF) includes a library definition portion 510, a vertex declaration portion 520, and a dependency definition portion 530. FIG. 14 shows an example of the library definition portion 510 of FIG. 13. Referring to FIG. 14, the library definition portion 510 includes a library definition start text 511, a library definition text 512, and a library definition end text 513. The library definition start text 511 and the library definition end text 513 are keywords to indicate the start and end of the library definition portion 510. In the library definition text 512, a library name 514 is a file name of a soft IP being referred and a library type 515 indicates the type of the netlist of the soft IP being referred and may be VHDL, VERILOG, XNP, or EDIF.

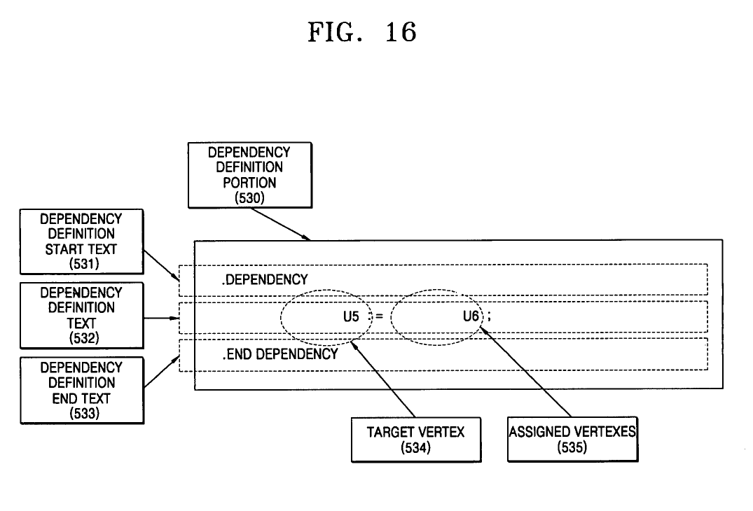

FIG. 15 shows an example of the vertex declaration portion 520 of FIG. 13. Referring to FIG. 15, the vertex declaration portion 520 includes a vertex declaration start text 521, a vertex declaration text 522, and a vertex declaration end text 523. The vertex declaration start text 521 and the vertex declaration end text 523 are keywords to indicate the start and end of the vertex declaration portion 520. The vertex declaration text 522 can be expressed by one or more vertexes. In the vertex declaration text 522, vertex names 524 signify the name of a vertex to be declared and correspond to the vertex names in the dotted box D of FIG. 9. An instance name 525 is an instance name corresponding to each vertex and corresponds to dotted boxes A of FIGS. 8 and 9. A component name 526 is a component name corresponding to each vertex and corresponds to dotted boxes B of FIGS. 8 and 9.

FIG. 16 shows an example of the dependency definition portion 530 of FIG. 13. Referring to FIG. 16, the dependency definition portion 530 includes a dependency definition start text 531, a dependency definition text 532, and a dependency definition end text 533. The dependency definition start text 531 and the dependency definition end text 533 are keywords to indicate the start and end of the dependency definition portion 530. The dependency definition text 532 can be expressed by one or more the dependencies between vertexes. For example, in the dependency definition text 532, a target vertex 534 signifies a dominant vertex and an assigned vertex 535 signifies dependent vertexes. As above, the vertexes for each constituent elements, that is, the dependent vertex that is dependent on other vertex, the dominant vertex that is dominant over other vertexes, and the absolute vertex that is self-recursive, are represented.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to the method of generating a dependency specification file of a soft IP according to the present invention, in order for a soft IP for designing a new or existing electronic circuit, which can exist parallel to an existing soft IP, to have a capacity of reconfiguration so that a user can easily edit, without an additional exclusive selection program, the inter-dependency information of the constituent elements existing in a soft IP is extracted and described as a specification.

According to the method of generating a dependency specification file of a soft IP according to the present invention, since a soft IP user can connect desired functions only using a DSF, unnecessary constituent elements can be easily removed so that the soft IP can be reduced. Also, since the DSF is a format which can be commonly applied to all IPs and there is no need to select a function block using an exclusive program, time and efforts needed to develop IPs can be reduced. As a result, the present method can be easily used for design and embodiment of a chip having a minimum area.

While this invention has been particularly shown and described with reference to preferred embodiments thereof, it will be understood by those skilled in the art that various changes in form and details may be made therein without departing from the spirit and scope of the invention as defined by the appended claims.

1. A method of generating a dependency specification file of a soft IP comprising:
extracting constituent element information by parsing a netlist file of a soft IP and designating an instance name and a component name to input and output ports and function blocks which are constituent elements existing in the soft IP;
converting the constituent element information to a vertex for each constituent element;
indicating a dependency specification between the vertexes for the respective constituent elements; and
generating a dependency specification file by converting the vertexes for the respective constituent elements and the dependency specification that the netlist file of the soft IP contains to an electronic circuit design language file, and outputting the dependency specification file.

2. The method as claimed in claim 1, wherein, in indicating a dependency specification, a degree of dependency between the vertexes for the respective constituent elements is defined.

3. The method as claimed in claim 1, wherein the vertexes for the respective constituent elements are classified as a dependent vertex that is dependent on other vertex, a dominant vertex that is dominant over other vertex, and an absolute vertex that is self-recursive.

4. The method as claimed in claim 1, wherein indicating a dependency specification comprises:
calculating the number of vertexes dependent on each vertex for each vertex;
determining whether the vertex is stable or unstable for each vertex according to the number of the dependent vertexes; and
removing vertexes corresponding to a predetermined removal rule.

5. The method as claimed in claim 4, wherein, in determining whether the vertex is stable or unstable, when the number of the vertexes that are dependent is one or more, the vertexes are determined to be stable and, when the number of the vertexes that are dependent is 0, the vertexes are determined to be unstable.

6. The method as claimed in claim 4, wherein removing vertexes comprises:
removing vertexes that are determined to be unstable; and
if a vertex where at least one vertex dependent on the vertex exists is to be removed, removing all vertexes that are in relation of the dependent vertex among the vertexes dependent on the vertex to be removed.

7. The method as claimed in claim 1, wherein the electronic circuit design language file includes VHDL (very high speed description language), VERILOG, XNF (xilinx netlists format), and EDIF (electronic data interchange format).

8. A recording medium storing computer readable and executable codes for generating a dependency specification file of a soft IP, the codes performing functions of:
extracting constituent element information by parsing a netlist file of a soft IP and designating an instance name and a component name to input and output ports and function blocks which are constituent elements existing in the soft IP;
converting the constituent element information to a vertex for each constituent element;
indicating a dependency specification between the vertexes for the respective constituent elements; and
generating a dependency specification file by converting the vertexes for the respective constituent elements and the dependency specification that the netlist file of the soft IP contains to an electronic circuit design language file, and outputting the dependency specification file.

9. The recording medium as claimed in claim 8, wherein the function of indicating a dependency specification comprises sub-functions of:
calculating the number of vertexes dependent on each vertex for each vertex;
determining whether the vertex is stable or unstable for each vertex according to the number of the dependent vertexes; and
removing vertexes corresponding to a predetermined removal rule.

10. The recording medium as claimed in claim 9, wherein the function of removing the vertex comprises sub-functions of:
removing vertexes that are determined to be unstable; and
if a vertex where at least one vertex dependent on the vertex exists is to be removed, removing all vertexes that are in relation of the dependent vertex among the vertexes dependent on the vertex to be removed.
